(19) United States
(12) Patent Application Publication
(10) Pub. No.: US 2018/0096632 A1
(43) Pub. Date: Apr. 5, 2018

(54) TECHNOLOGY TO PROVIDE VISUAL CONTEXT TO THE VISUALLY IMPAIRED

(71) Applicants: Omar U. Florez, Sunnyvale, CA (US); Rita H. Wouhaybi, Portland, OR (US); Lenitra M. Durham, Beaverton, OR (US); Giuseppe Raffa, Portland, OR (US); Jonathan J. Huang, Pleasanton, CA (US); Chieh-Yih Wan, Beaverton, OR (US); Lama Nachman, Santa Clara, CA (US)

(72) Inventors: Omar U. Florez, Sunnyvale, CA (US); Rita H. Wouhaybi, Portland, OR (US); Lenitra M. Durham, Beaverton, OR (US); Giuseppe Raffa, Portland, OR (US); Jonathan J. Huang, Pleasanton, CA (US); Chieh-Yih Wan, Beaverton, OR (US); Lama Nachman, Santa Clara, CA (US)

(21) Appl. No.: 15/282,690

(22) Filed: Sep. 30, 2016

(51) Int. Cl. G09B 21/00; G06K 9/00; G06K 9/46; G10L 25/51; G10L 25/30; G08B 21/02; G10L 13/04

(52) U.S. Cl. CPC G09B 21/007; G06K 9/00671; G06K 9/4628; G10L 13/043; G10L 25/30; G08B 21/02; G10L 25/51

(57) ABSTRACT

Systems, apparatuses and methods may leverage technology that generates textual descriptions of scenes based on visual content and audio content and generates haptic signals based on the textual descriptions if the textual descriptions satisfy a safety-related condition. Additionally, audio output signals may be generated based on the textual descriptions if the textual descriptions do not satisfy the safety-related conditions. In one example, a complex neural network (CNN) is trained and used to generate the textual descriptions in real-time.

### TECHNICAL FIELD

Embodiments generally relate to technology that assists the visually impaired. More particularly, embodiments relate to technology that provides visual context to the visually impaired.

### BACKGROUND

Visually impaired individuals may rely on other senses such as sound and touch to discover details of their environment and identify potentially dangerous situations. In rapidly changing settings, however, such as crowded rooms or busy intersections, mere sounds or tactile feedback alone may be insufficient to protect visually impaired individuals from harm. While service animals may be helpful, there remains considerable room for concern.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a visual impairment cane system according to an embodiment;

FIG. 2 is a flowchart of an example of a method of operating a contextual assistance apparatus according to an embodiment;

FIG. 3 is a flowchart of an example of a method of training a convolutional neural network according to an embodiment;

FIG. 4 is a flowchart of an example of a method of obtaining textual descriptions of scenes according to an embodiment;

FIG. 5 is an illustration of an example of a convolutional neural network according to an embodiment;

FIG. 6 is a block diagram of an example of a system including a contextual assistance apparatus according to an embodiment;

FIG. 7 is a block diagram of an example of a processor according to an embodiment; and

FIG. 8 is a block diagram of an example of a computing system according to an embodiment.

### DESCRIPTION OF EMBODIMENTS

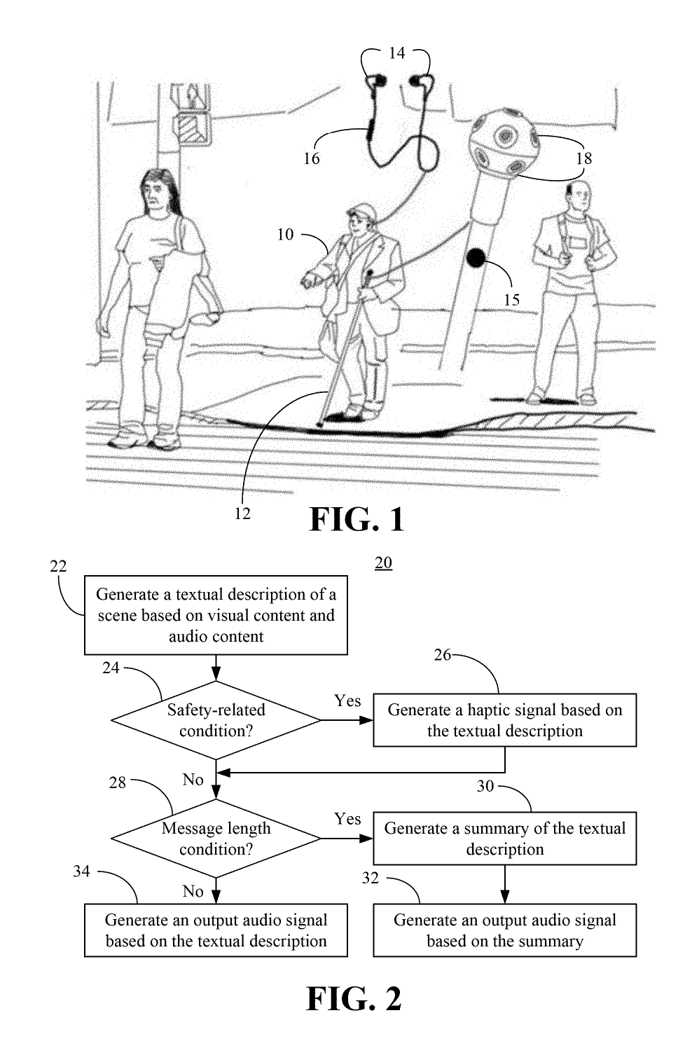

Turning now to FIG. 1, an environment is shown in which an individual 10 having a visual impairment carries a visual impairment cane system 12 while traveling in/through the environment. The visual impairment of the individual 10 may be total or partial blindness or any other lack of vision (due to, e.g., tiredness, migraine, intoxication, missing corrective lenses, darkness, etc.). In the illustrated example, the system 12 includes a housing with a cane form factor, a headset 14, a microphone 16 and a plurality of cameras 18. The system 12 may also include a button 15 that enables the individual 10 to power the system 12 on or off, enter requests for information, and so forth. As will be discussed in greater detail, the system 12 may provide contextual assistance to the individual 10 in settings such as crowded rooms, busy intersections, etc., where the other senses of the individual 10 (e.g., sound, smell, touch) may be overloaded or otherwise challenged. In general, the system 12 may use visual content (e.g., still images, video signals) obtained from the cameras 18 and the microphone 16 to continually narrate the environment. In particularly hazardous situations, the system 12 may also provide instantaneous haptic/vibratory feedback to the individual 10.

FIG. 2 shows a method 20 of operating a contextual assistance apparatus. The method 20 may generally be implemented in a system such as, for example, the visual impairment cane system 12 (FIG. 1), already discussed. More particularly, the method 20 may be implemented in one or more modules as a set of logic instructions stored in a machine- or computer-readable storage medium such as random access memory (RAM), read only memory (ROM), programmable ROM (PROM), firmware (FW), flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in method 20 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 22 provides for generating a textual description of a scene based on visual content and audio content. Block 22 may also generate the textual description based on other information such as, for example, geolocation (e.g., Global Positioning System/GPS) data, proximity (e.g., near field communication/NFC, Bluetooth) data, inertia (e.g., accelerometer, gyroscope) data, map data, and so forth. Additionally, a convolutional neural network (CNN) may be used to generate the textual description, as will be discussed in greater detail. Thus, the output of block 22 might be “traffic light is red and there are two people around you. The person in front is crossing the street now while the one behind you is still waiting.” Another example might be “there are two doors and a passage in front of you, the left door is closed.” A determination may be made at block 24 as to whether the textual description satisfies a safety-related condition such as, for example, traffic or other dangerous events being detected in the vicinity of the individual. If the safety-related condition is satisfied, illustrated block 26 generates a haptic signal based on the textual description. Block 26 might therefore apply a rapid succession of pulses to a cane being held by the individual in order to instruct the individual to stop, back-up, move left, and so forth. The sequence, timing and/or intensity of the pulses may vary based on the type of event and/or the instruction being communicated.

If the safety-related condition is not satisfied (or upon completion of the haptic signal generation), block 28 may determine whether the textual description satisfies a message length condition (e.g., text description is longer than twenty words). If so, block 30 may generate a summary of the textual description (e.g., “red traffic light”). An output audio signal (e.g., narration) may be generated at block 32 based on the summary. If the safety-related condition is not satisfied, illustrated block 34 generates an output audio signal (e.g., narration) based on the entire textual description. Blocks 32 and 34 may therefore involve text-to-speech processing, wherein the results are sent to a headset such as, for example, the headset 14 (FIG. 1), already discussed.

Blocks 32 and 34 may also store a relationship between the scene and the output audio signal in, for example, a database. In this regard, the database may be shared with a plurality of individuals. Thus, subsequent visitors to the same scene may be provided with the previously generated output audio signal or a modified version of the previously generated output audio signal. The sharing of the database, preexisting textual descriptions and/or previously generated output audio signals might be accomplished via a cloud computing infrastructure, a peer-to-peer network, etc., or any combination thereof. Moreover, sharing might also be triggered by particular types of events such as, for example, in the case of an accident where multiple devices and users are prompted to collaborate in the capture of evidence relating to the accident. In one example, only the dynamic aspects (e.g., people walking by, birds flying overhead) of the preexisting textual description are updated, with the static aspects (e.g., buildings, doorways) being repeated from previous narrations. Moreover, a time to live attribute may be assigned to certain elements (e.g., dynamic aspects) of the scene in order to effectively label them as “one time” events.

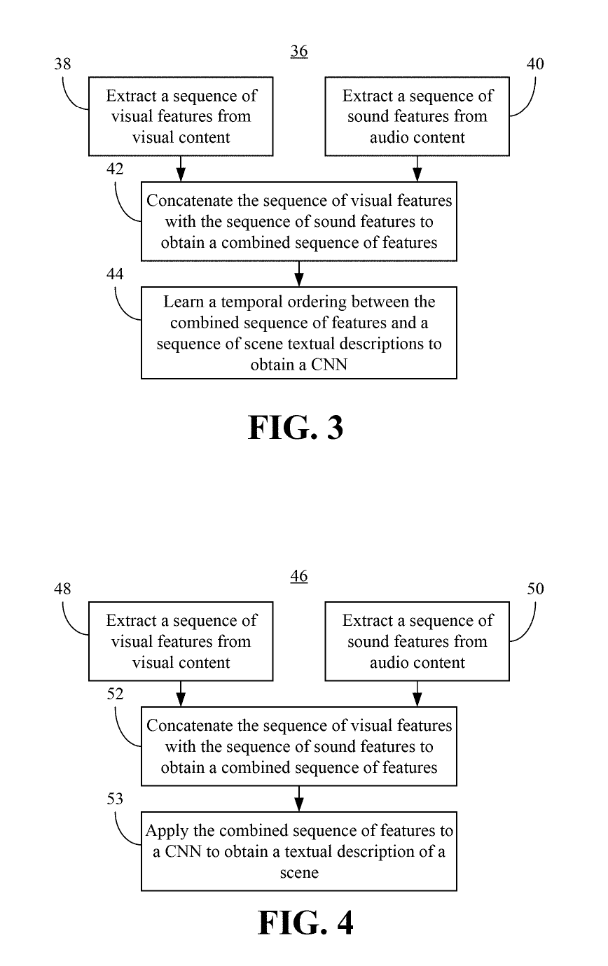

Turning now to FIG. 3, a method 36 of training a convolutional neural network (CNN) is shown. The method 36 may be implemented in one or more modules as a set of logic instructions stored in a machine- or computer-readable storage medium such as RAM, ROM, PROM, FW, flash memory, etc., in configurable logic such as, for example, PLAs, FPGAs, CPLDs, in fixed-functionality logic hardware using circuit technology such as, for example, ASIC, CMOS or TTL technology, or any combination thereof.

In the illustrated example, a sequence of visual features is extracted from visual content at block 38 and a sequence of sound features is extracted from audio content at block 40. Additionally, the sequence of visual features may be concatenated with the sequence of sound features at block 42 to obtain a combined sequence of features. The concatenation may be linear or nonlinear. Illustrated block 44 learns a temporal ordering between the combined sequence of features and a sequence of scene textual descriptions obtained from a recurrent neural network (RNN) that is trained to learn a relatively large amount of sentences describing daily activities and common locations. For example, titles of pictures in social networking sites may be sources of this type of data. Block 44 may also use other information such as geolocation data, proximity data, inertia data, map data, and so forth, to train the CNN.

FIG. 4 shows a method 46 of obtaining textual descriptions. The method 46 may be readily substituted for block 22 (FIG. 2), already discussed. More particularly, the method 46 may be implemented in one or more modules as a set of logic instructions stored in a machine- or computer-readable storage medium such as RAM, ROM, PROM, FW, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 48 provides for extracting a sequence of visual features from visual content, wherein block 40 may extract a sequence of sound features from audio content. The sequence of visual features may be concatenated with the sequence of sound features at block 52. The concatenation may be linear or non-linear. In one example, the combined sequence of features is applied to a CNN to obtain a textual description of a scene at block 53. Block 53 may also apply sensor data such as, for example, geolocation data, proximity data, inertia data, map data, etc., or any combination thereof to the CNN to obtain the textual description. In such a case, block 53 may also store a relationship between the scene and the sensor data, wherein the stored relationship may facilitate reuse of the textual description for other users encountering the same scene/location.

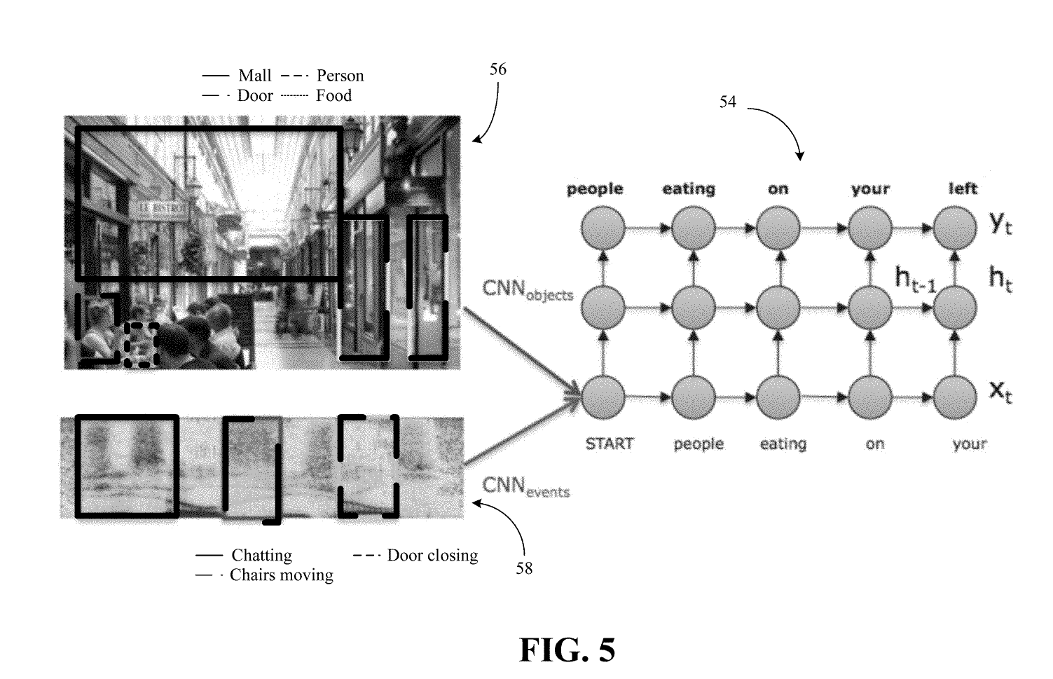

FIG. 5 shows a CNN 54 that may be used to generate textual descriptions based on visual features (e.g., mall, door, person, food) extracted from visual content 56 (e.g., video, still image, etc.) of a scene and sound features (e.g., chatting, chairs moving, doors closing) extracted from audio content 58 (e.g., microphone signal) associated with the scene. Thus, a system containing the CNN 54 may consider the objects and events recognized by the CNN 54 as starting points for previously learned word sequences in a trained RNN. In the illustrated example, a given input word xₜ₋₁ is used to predict the next output word yₜ according to the transfer function hₜ. For example, if a person and a chatting audio event are recognized, there might be a word “people” that strongly correlates to these two concepts. Accordingly, the word “people” may become the starting point of a sequence and the next word may be predicted based on knowledge that the word “people” is evidence from the previous time step. The illustrated CNN 54 discovers one word at a time to generate a sequence that optimizes the presence of different objects and audio events within the current time window until it reaches a final “END” state with high a probability. Finally, the generated narration may be converted to speech and presented to the user.

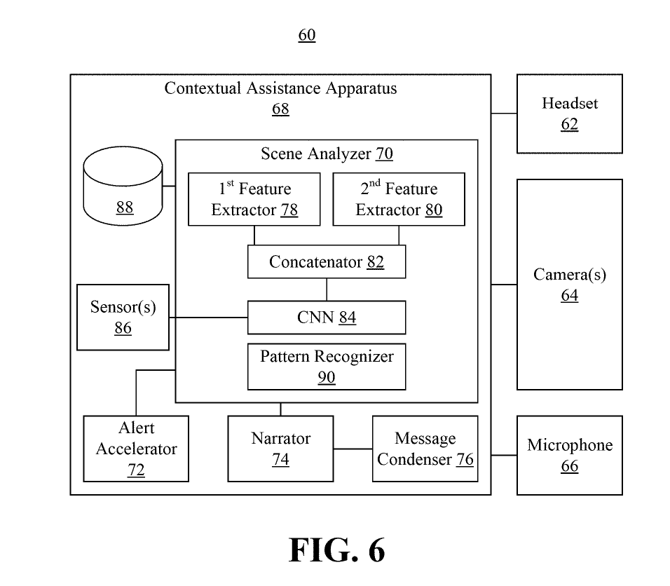

FIG. 6 shows a system 60 that may automatically provide visual context to the visually impaired. The system 60 may be readily substituted for the visual impairment cane system 12 (FIG. 1), already discussed. Portions of the system 60 may also be implemented in a cloud computing infrastructure, remote server, etc. The illustrated system 60 includes a headset 62, one or more cameras 64 to generate visual content, a microphone 66 to generate audio content and a contextual assistance apparatus 68 communicatively coupled to the one or more cameras 64, the microphone 66 and the headset 62. The contextual assistance apparatus 68, which may include logic instructions, configurable logic, fixed-functionality logic hardware, etc., or any combination thereof, may generally implement one or more aspects of the method 20 (FIG. 2), the method 36 (FIG. 3) and/or the method 46 (FIG. 4).

More particularly, the apparatus 68 may include a scene analyzer 70 to generate textual descriptions of scenes based on the visual content and the audio content. Additionally, an alert accelerator 72 may be communicatively coupled to the scene analyzer 70 in order to generate haptic signals based on the textual descriptions if the textual descriptions satisfy a safety-related condition. In one example, the alert accelerator 72 includes a vibratory motor positioned in physical contact of the housing of the system 60. The apparatus 68 may also include a narrator 74 communicatively coupled to the scene analyzer 70, wherein the narrator 74 is configured to generate an output audio signal via the headset 62 based on the textual descriptions if the textual descriptions do not satisfy the safety-related conditions.

If multiple textual descriptions are generated for the same scene, the narrator 74 may rank the textual descriptions according to a predefined utility function (e.g., dangerous, crowded, traffic related, particular interest) and select the most suitable description to convert into the output audio signal. The apparatus 68 may also collect feedback from the user, wherein the narrator 74 is able to distinguish between explicit and implicit feedback. For example, explicit feedback might occur when the user receives a high level narration (e.g., “interesting store to your right”) and responds by stating an interest in knowing more about (e.g., “Say more”). By contrast, implicit feedback may occur when one or more sensors 86 detect the presence of other individuals who might be able to provide “before action” input. For example, a friend might be walking with a blind person and the contextual assistance apparatus 68 might learn whether a recommendation of crossing the street was appropriate based on the behavior of the friend. In one example, a message condenser 76 generates summaries of the textual descriptions if the textual descriptions satisfy a message length condition, wherein the audio output signal is generated based on the summary.

The scene analyzer 70 may include a first feature extractor 78 to extract sequences of visual features from the visual content and a second feature extractor 80 to extract sequences of sound features from the audio content. A concatenator 82 may concatenate the sequences of visual features with the sequences of sound features to obtain combined sequences of features. Moreover, a CNN 84 may generate the textual descriptions based on the combined sequences of features. In one example, the CNN 84 generates the textual descriptions further based on geolocation data, proximity data, inertia data, map data, etc., obtained from one or more of the sensors 86. In this regard, the apparatus 68 may also include a database 88 to store relationships between the scenes and the data obtained from the sensors 86. The scene analyzer 70 may also update preexisting textual descriptions to obtain the textual descriptions.

The database 88 may also store relationships between the scenes and the output audio signal (e.g., storing narrations for future use in the same location). Additionally, the apparatus 68 may include a pattern recognizer 90 to assign time to live attributes to the relationships between the scenes and the output audio signal.

Indeed, generated descriptions may be tagged to specific locations in order to facilitate consumption by other (e.g., non-visually impaired) people subsequently transmitting the same area. For example, the following narrations—“construction work in this area with few people walking in this side of the street”, and “a new grocery store opened in this street”—might be saved and replayed to other potential users. The information may also be refined as time goes by and more data is collected. For example, the refinement may reflect the fact that the construction might have moved or someone walking on the opposite side of the street might have a better line of vision than the initial user. The systems may collaborate in the moment or through cumulative data that either augments or negates a previous observation.

For example, tourists may benefit from having the system translate features in the area into languages with which they have more familiarity or perhaps to help bridge cultural differences in representations of items. Tourists may receive a description of not only how things appear now but some details on how things would be different during a different time of year (e.g., describing how a scene would look in spring to an individual who is visiting the scene in winter). Another consideration is that there is a spectrum of visual impairment. In other words, certain people may have some vision, while others may have no vision. Similarly, some people might have trouble seeing at night. In such a case, the system 60 may generate a description of the scene as if it were during the day in order to provide details that the user may miss in the dark.

In addition to visual and cultural impairments, people may also have height or hearing impairments that may benefit from added contextual information in dynamic situations. Indeed, children often see the world in an entirely different light than their taller parents and each could receive descriptions of the environment to gain insight into what the other is experiencing. In yet another example, people of different ages may have interest in different things in the public space and may benefit by having the system 60 provide insight as to how others in their age group and/or with similar challenges and interests navigated the area. Moreover, individuals in wheelchairs or those requiring the use of canine companion may benefit from having additional sensory assistance during navigation. Indeed, the output of the contextual assistance apparatus 68 may also be used to control wheelchair behavior.

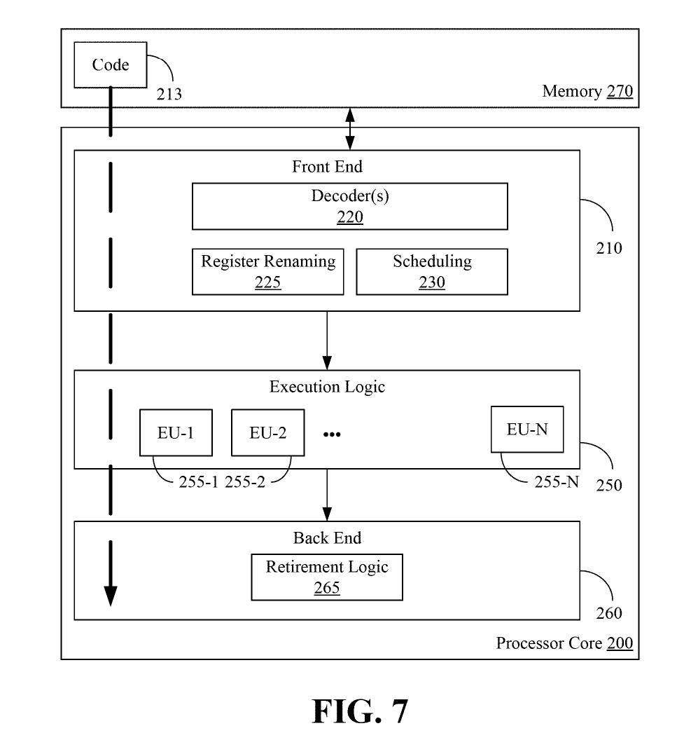

FIG. 7 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 7, a processing element may alternatively include more than one of the processor core 200 illustrated in FIG. 7. The processor core 200 may be a single-threaded core or, for at least one embodiment, the processor core 200 may be multithreaded in that it may include more than one hardware thread context (or “logical processor”) per core.

FIG. 7 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 20 (FIG. 2), the method 36 (FIG. 3) and/or the method 46 (FIG. 4), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 7, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

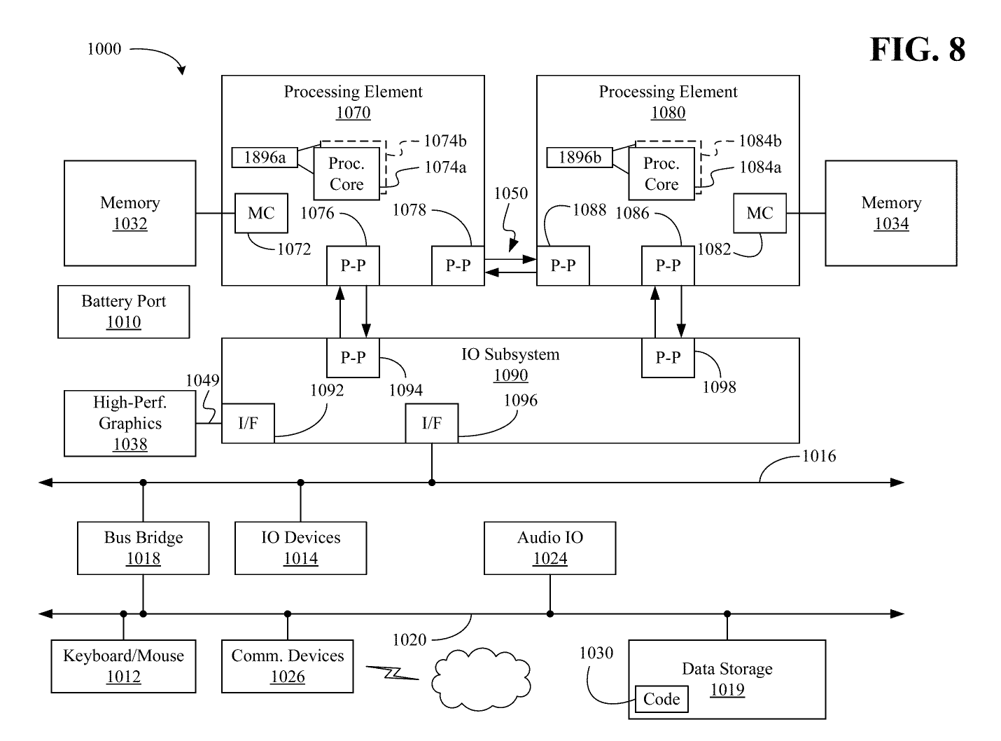

Referring now to FIG. 8, shown is a block diagram of a computing system 1000 embodiment in accordance with an embodiment. Shown in FIG. 8 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 8 may be implemented as a multi-drop bus rather than point-to-point interconnect.

As shown in FIG. 8, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 7.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 8, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 8, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 8, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 20 (FIG. 2), the method 36 (FIG. 3) and/or the method 46 (FIG. 4), already discussed, and may be similar to the code 213 (FIG. 7), already discussed. Further, an audio I/O 1024 may be coupled to second bus 1020 and a battery port 1010 may supply power to the computing system 1000.

Note that other embodiments are contemplated. For example, instead of the point-to-point architecture of FIG. 8, a system may implement a multi-drop bus or another such communication topology. Also, the elements of FIG. 8 may alternatively be partitioned using more or fewer integrated chips than shown in FIG. 8.

### ADDITIONAL NOTES AND EXAMPLES

Example 1 may include a visual impairment cane system comprising a housing including a cane form factor, a headset, one or more cameras to generate visual content, a microphone to generate audio content, and a contextual assistance apparatus communicatively coupled to the one or more cameras, the microphone and the headset, the contextual assistance apparatus including a scene analyzer to generate a textual description of a scene based on the visual content and the audio content, an alert accelerator communicatively coupled to the scene analyzer, the alert accelerator to generate a haptic signal based on the textual description if the textual description satisfies a safety-related condition, and a narrator communicatively coupled to the scene analyzer, the narrator to generate an output audio signal via the headset based on the textual description if the textual description does not satisfy the safety-related condition.

Example 2 may include the system of Example 1, wherein the scene analyzer includes a first feature extractor to extract a sequence of visual features from the visual content, a second feature extractor to extract a sequence of sound features from the audio content, a concatenator to concatenate the sequence of visual features with the sequence of sound features to obtain a combined sequence of features, and a convolutional neural network to generate the textual description based on the combined sequence of features.

Example 3 may include the system of Example 2, wherein the convolutional neural network is to generate the textual description further based on one or more of geolocation data, proximity data, inertia data or map data and the contextual assistance apparatus further includes a database to store a relationship between the scene and the one or more of geolocation data, proximity data, inertia data or map data.

Example 4 may include the system of any one of Examples 1 to 3, wherein the contextual assistance apparatus further includes a message condenser to generate a summary of the textual description if the textual description satisfies a message length condition, wherein the output audio signal is to be generated based on the summary.

Example 5 may include the system of Example 1, wherein the contextual assistance apparatus further includes a database to store a relationship between the scene and the output audio signal.

Example 6 may include a contextual assistance apparatus comprising a scene analyzer to generate a textual description of a scene based on visual content and audio content, an alert accelerator communicatively coupled to the scene analyzer, the alert accelerator to generate a haptic signal based on the textual description of the textual description satisfies a safety-related condition, and a narrator communicatively coupled to the scene analyzer, the narrator to generate an output audio signal based on the textual description if the textual description does not satisfy the safety-related condition.

Example 7 may include the apparatus of Example 6, wherein the scene analyzer includes a first feature extractor to extract a sequence of visual features from the visual content, a second feature extractor to extract a sequence of sound features from the audio content, a concatenator to concatenate the sequence of visual features with the sequence of sound features to obtain a combined sequence of features, and a convolutional neural network to generate the textual description based on the combined sequence of features.

Example 8 may include the apparatus of Example 7, wherein the convolutional neural network is to generate the textual description further based on one or more of geolocation data, proximity data, inertia data or map data and the apparatus further includes a database to store a relationship between the scene and the one or more of geolocation data, proximity data, inertia data or map data.

Example 9 may include the apparatus of any one of Examples 6 to 8, further including a message condenser to generate a summary of the textual description if the textual description satisfies a message length condition, wherein the output audio signal is to be generated based on the summary.

Example 10 may include the apparatus of Example 6, further including a database to store a relationship between the scene and the output audio signal.

Example 11 may include the apparatus of Example 10, further including a pattern recognizer to assign a time to live attribute to the relationship between the scene and the output audio signal.

Example 12 may include the apparatus of Example 6, wherein the scene analyzer is to update a preexisting textual description to obtain the textual description.

Example 13 may include a method of operating a contextual assistance apparatus, comprising generating a textual description of a scene based on visual content and audio content, generating a haptic signal based on the textual description if the textual description satisfies a safety-related condition and generating an output audio signal based on the textual description if the textual description does not satisfy the safety-related condition.

Example 14 may include the method of Example 13, wherein generating the textual description includes extracting a sequence of visual features from the visual content, extracting a sequence of sound features from the audio content, concatenating the sequence of visual features with the sequence of sound features to obtain a combined sequence of features, and applying the combined sequence of features to a convolutional neural network.

Example 15 may include the method of Example 13, further including applying one or more of geolocation data, proximity data, inertia data or map data to the convolutional neural network to obtain the textual description, and storing a relationship between the scene and the one or more of geolocation data, proximity data, inertia data or map data.

Example 16 may include the method of any one of Examples 13 to 15, further including generating a summary of the textual description if the textual description satisfies a message length condition, wherein the output audio signal is generated based on the summary.

Example 17 may include the method of Example 13, further including storing a relationship between the scene and the output audio signal.

Example 18 may include at least one computer readable storage medium comprising a set of instructions, which when executed by a computing device, cause the computing device to generate a textual description of a scene based on visual content and audio content, generate a haptic signal based on the textual description if the textual description satisfies a safety-related condition, and generate an output audio signal based on the textual description if the textual description does not satisfy the safety-related condition.

Example 19 may include the at least one computer readable storage medium of Example 18, wherein the instructions, when executed, cause a computing device to extract a sequence of visual features from the visual content, extract a sequence of sound features from the audio content, concatenate the sequence of visual features with the sequence of sound features to obtain a combined sequence of features, and apply the combined sequence of features to a convolutional neural network to obtain the textual description.

Example 20 may include the at least one computer readable storage medium of Example 19, wherein the instructions, when executed, cause a computing device to, apply one or more of geolocation data, proximity data, inertia data or map data to the convolutional neural network to obtain the textual description, and store a relationship between the scene and the one or more of geolocation data, proximity data, inertia data or map data.

Example 21 may include the at least one computer readable storage medium of any one of Examples 18 to 21, wherein the instructions, when executed, cause a computing device to generate a summary of the textual description if the textual description satisfies a message length condition, and wherein the output audio signal is to be generated based on the summary.

Example 22 may include the at least one computer readable storage medium of Example 18, wherein the instructions, when executed, cause a computing device to store a relationship between the scene and the output audio signal.

Example 23 may include the at least one computer readable storage medium of Example 22, wherein the instructions, when executed, cause a computing device to assign a time to live attribute to the relationship between the scene and the output audio signal.

Example 24 may include the at least one computer readable storage medium of Example 18, wherein the instructions, when executed, cause a computing device to update a preexisting textual description to obtain the textual description.

Example 25 may include a contextual assistance apparatus comprising means for generating a textual description of a scene based on visual content and audio content, means for generating a haptic signal based on the textual description if the textual description satisfies a safety-related condition, and means for generating an output audio signal based on the textual description if the textual description does not satisfy the safety-related condition.

Example 26 may include the apparatus of Example 25, wherein the means for generating the textual description includes means for extracting a sequence of visual features from the visual content, means for extracting a sequence of sound features from the audio content, means for concatenating the sequence of visual features with the sequence of sound features to obtain a combined sequence of features, and means for applying the combined sequence of features to a convolutional neural network.

Example 27 may include the apparatus of Example 25, further including means for applying one or more of geolocation data, proximity data, inertia data or map data to the convolutional neural network to obtain the textual description, and means for storing a relationship between the scene and the one or more of geolocation data, proximity data, inertia data or map data.

Example 28 may include the apparatus of any one of Examples 25 to 27, further including means for generating a summary of the textual description if the textual description satisfies a message length condition, wherein the output audio signal is to be generated based on the summary.

Example 29 may include the apparatus of Example 25, further including means for storing a relationship between the scene and the output audio signal.

Thus, technology described herein may enable textual descriptions to be learned from both images and audio. The textual descriptions may be used to provide narrations to individuals in order to guide the individuals and reduce uncertainty in dynamic scenarios. Deep learning may enable reliable recognition of objects in images and events in audio. Moreover, a collaborative system may predict what the user will encounter based on previous recordings and/or context information associated with the scene/area.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system comprising:
a housing including a cane form factor;
a headset;
one or more cameras to generate visual content;
a microphone to generate audio content; and
a contextual assistance apparatus communicatively coupled to the one or more cameras, the microphone and the headset, the contextual assistance apparatus including,
a scene analyzer to generate a textual description of a scene based on the visual content and the audio content,
an alert accelerator communicatively coupled to the scene analyzer, the alert accelerator to generate a haptic signal based on the textual description if the textual description satisfies a safety-related condition, and
a narrator communicatively coupled to the scene analyzer, the narrator to generate an output audio signal via the headset based on the textual description if the textual description does not satisfy the safety-related condition.

2. The system of claim 1, wherein the scene analyzer includes:
a first feature extractor to extract a sequence of visual features from the visual content;
a second feature extractor to extract a sequence of sound features from the audio content;
a concatenator to concatenate the sequence of visual features with the sequence of sound features to obtain a combined sequence of features; and
a convolutional neural network to generate the textual description based on the combined sequence of features.

3. The system of claim 2, wherein the convolutional neural network is to generate the textual description further based on one or more of geolocation data, proximity data, inertia data or map data and the contextual assistance apparatus further includes a database to store a relationship between the scene and the one or more of geolocation data, proximity data, inertia data or map data.

4. The system of claim 1, wherein the contextual assistance apparatus further includes a message condenser to generate a summary of the textual description if the textual description satisfies a message length condition, wherein the output audio signal is to be generated based on the summary.

5. The system of claim 1, wherein the contextual assistance apparatus further includes a database to store a relationship between the scene and the output audio signal.

6. An apparatus comprising:
a scene analyzer to generate a textual description of a scene based on visual content and audio content;
an alert accelerator communicatively coupled to the scene analyzer, the alert accelerator to generate a haptic signal based on the textual description if the textual description satisfies a safety-related condition; and
a narrator communicatively coupled to the scene analyzer, the narrator to generate an output audio signal based on the textual description if the textual description does not satisfy the safety-related condition.

7. The apparatus of claim 6, wherein the scene analyzer includes:
a first feature extractor to extract a sequence of visual features from the visual content;
a second feature extractor to extract a sequence of sound features from the audio content;
a concatenator to concatenate the sequence of visual features with the sequence of sound features to obtain a combined sequence of features; and
a convolutional neural network to generate the textual description based on the combined sequence of features.

8. The apparatus of claim 7, wherein the convolutional neural network is to generate the textual description further based on one or more of geolocation data, proximity data, inertia data or map data and the apparatus further includes a database to store a relationship between the scene and the one or more of geolocation data, proximity data, inertia data or map data.

9. The apparatus of claim 6, further including a message condenser to generate a summary of the textual description if the textual description satisfies a message length condition, wherein the output audio signal is to be generated based on the summary.

10. The apparatus of claim 6, further including a database to store a relationship between the scene and the output audio signal.

11. The apparatus of claim 10, further including a pattern recognizer to assign a time to live attribute to the relationship between the scene and the output audio signal.

12. The apparatus of claim 6, wherein the scene analyzer is to update a preexisting textual description to obtain the textual description.

13. A method comprising:
generating a textual description of a scene based on visual content and audio content;
generating a haptic signal based on the textual description if the textual description satisfies a safety-related condition; and
generating an output audio signal based on the textual description if the textual description does not satisfy the safety-related condition.

14. The method of claim 13, wherein generating the textual description includes:
extracting a sequence of visual features from the visual content;
extracting a sequence of sound features from the audio content;
concatenating the sequence of visual features with the sequence of sound features to obtain a combined sequence of features; and
applying the combined sequence of features to a convolutional neural network.

15. The method of claim 13, further including:
applying one or more of geolocation data, proximity data, inertia data or map data to the convolutional neural network to obtain the textual description; and
storing a relationship between the scene and the one or more of geolocation data, proximity data, inertia data or map data.

16. The method of claim 13, further including generating a summary of the textual description if the textual description satisfies a message length condition, wherein the output audio signal is generated based on the summary.

17. The method of claim 13, further including storing a relationship between the scene and the output audio signal.

18. At least one computer readable storage medium comprising a set of instructions, which when executed by a computing device, cause the computing device to:
generate a textual description of a scene based on visual content and audio content;
generate a haptic signal based on the textual description if the textual description satisfies a safety-related condition; and
generate an output audio signal based on the textual description if the textual description does not satisfy the safety-related condition.

19. The at least one computer readable storage medium of claim 18, wherein the instructions, when executed, cause a computing device to:
extract a sequence of visual features from the visual content;
extract a sequence of sound features from the audio content;
concatenate the sequence of visual features with the sequence of sound features to obtain a combined sequence of features; and
apply the combined sequence of features to a convolutional neural network to obtain the textual description.

20. The at least one computer readable storage medium of claim 19, wherein the instructions, when executed, cause a computing device to:
apply one or more of geolocation data, proximity data, inertia data or map data to the convolutional neural network to obtain the textual description; and
store a relationship between the scene and the one or more of geolocation data, proximity data, inertia data or map data.

21. The at least one computer readable storage medium of claim 18, wherein the instructions, when executed, cause a computing device to generate a summary of the textual description if the textual description satisfies a message length condition, and wherein the output audio signal is to be generated based on the summary.

22. The at least one computer readable storage medium of claim 18, wherein the instructions, when executed, cause a computing device to store a relationship between the scene and the output audio signal.

23. The at least one computer readable storage medium of claim 22, wherein the instructions, when executed, cause a computing device to assign a time to live attribute to the relationship between the scene and the output audio signal.

24. The at least one computer readable storage medium of claim 18, wherein the instructions, when executed, cause a computing device to update a preexisting textual description to obtain the textual description.
